(19) United States
(12) Patent Application Publication
(10) Pub. No.: US 2008/0211930 A1
(43) Pub. Date: Sep. 4, 2008

(54) Intelligent Rapid Camera

(76) Inventor: Valery Valle, Latille (FR)

Correspondence Address: ARENT FOX LLP, 1050 CONNECTICUT AVENUE, N.W., SUITE 400, WASHINGTON, DC, 20036, US

(21) Appl. No.: 11/997,972

(22) PCT Filed: Aug. 3, 2006
(86) PCT No.: PCT/FR2006/001892

§ 371 Date: Apr. 23, 2008

(30) Foreign Application Priority Data
Aug. 5, 2005 (FR) 0508395

(51) Int. Cl. H04N 5/76

(52) U.S. Cl. 348/231.99

(57) ABSTRACT

The invention relates to a high-speed camera comprising at least one image-forming lens (1) and a plurality of acquisition modules, each module comprising a shutter means (2) and an image-forming means (2a), an image-digitising means (3) and a means for storing a digitised image (3a). The high-speed camera also comprises control means (4) for controlling each of the shutter means, which can open same for a pre-determined exposure time. The invention is characterised in that the image-forming means is arranged such as to receive the image from the shutter means. The invention is also characterised in that the high-speed camera comprises a management means (5) for managing the digitising means 3), said management means being synchronised with the above-mentioned control means such as to activate digitisation when the shutter means associated with the digitising means in an acquisition module is open.

The present invention relates to the field of image acquisition equipment.

The present invention relates more particularly to an ultra-rapid camera.

The prior art already knows rapid cameras permitting acquisition frequencies for example of around 2000 images per second.

The application EP 1 176 812 sets out to increase further the frequency of acquisition by disclosing a rapid camera comprising a means of splitting the incident rays to four acquisition means. The rays obtained are then intensified and imaged by four CCD cameras, the acquisition times of which are offset with respect to one another.

Such a method is limited by the splitting of the incident rays, which complicates the optical device, which must comprise a pyramidal prism.

In addition, synchronous control of the cameras requires very complex electronics developed specifically for the sensors used. The example of a camera given (C7300) requires as many acquisition cards as there are cameras employed, giving rise to a limitation in the number of possible images.

The prior art also knows ultra-rapid cameras of the type marketed by the company LaVision under the trade name UltraSpeedStar. Such cameras can achieve performances relating to frequency of acquisition of around 1 MHz for one image frame. Such a camera comprises a sensor segmented into different CMOS zones, each CMOS zone being successively activated.

Such a camera has the drawback of being very expensive because of the need for a very specific segmented sensor.

An additional drawback of such a device is that the increase in the number of images recorded is achieved to the detriment of the resolution of these images, the sensor used having a fixed resolution.

It is therefore necessary to provide an ultra-rapid camera while reducing the cost of such a camera. In particular, if a standard camera is used, having a relatively long acquisition time, it is necessary to be able to capture images over short times.

The publication “High Performance Imaging using Large Camera Array”, Wilburn et al, 2005 is also known, which teaches a camera comprising at least one objective able to form an image, and a plurality of acquisition modules, each of the said modules comprising an obturation means and an image formation means, an image digitisation means and a means for storing a digitised image, the said rapid camera also comprising means of controlling each of the said obturation means able to open them for a predetermined exposure time.

However, nothing in the aforementioned publication makes it possible to provide an ultra-rapid camera comprising modules with a relatively long acquisition time.

One of the objects of the present invention is therefore to be able to capture image frames over relatively short times, and therefore at a high frequency, while allowing the use of standard cameras with a relatively long acquisition time.

To do this, the present invention concerns a rapid camera comprising at least one objective (1) able to form an image, and a plurality of acquisition modules, each of the said modules comprising an obturation means (2) and an image formation means (2a), an image digitisation means (3) and a means for storing a digitised image (3a), the said rapid camera also comprising means (4) of controlling each of the said obturation means able to open them for a predetermined exposure time, characterised in that

the said image formation means is arranged to receive the said image from the said obturation means, and in that
the said rapid camera comprises a fine control means (5) arranged to fine control the said digitisation means (3), the said fine control means being synchronised with the said control means so as to activate the digitisation when the said obturation means associated with the said digitisation means within an acquisition module is open.

For the purpose of the present application, “rapid camera” will mean the camera formed by all the acquisition modules according to the invention.

Any cameras included in the acquisition modules will be called “standard cameras”.

According to the invention, the fact that the fine control means is synchronised with the control means so as to activate the digitisation when the obturation means is open allows the use of standard cameras with relatively long acquisition times as an acquisition module for forming an ultra-rapid camera.

The invention will be better understood with the help of the description, given below for purely explanatory purposes, of one embodiment of the invention, with reference to the accompanying figures:

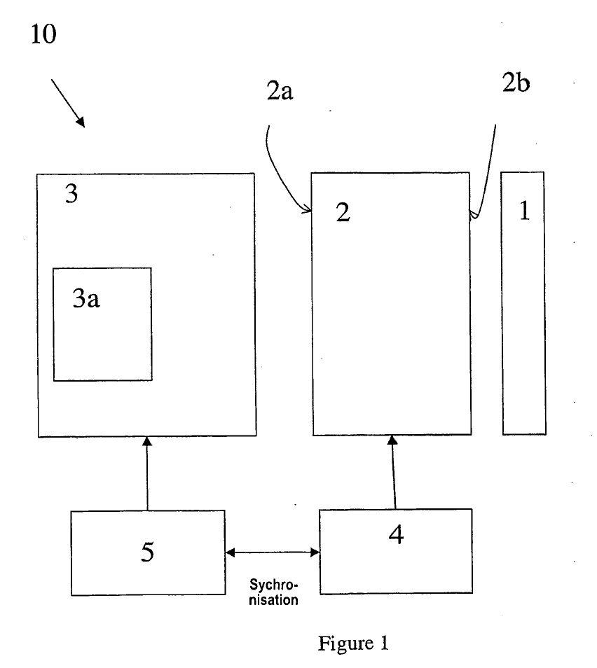

FIG. 1 depicts schematically one of the acquisition modules included in the rapid camera according to the invention;

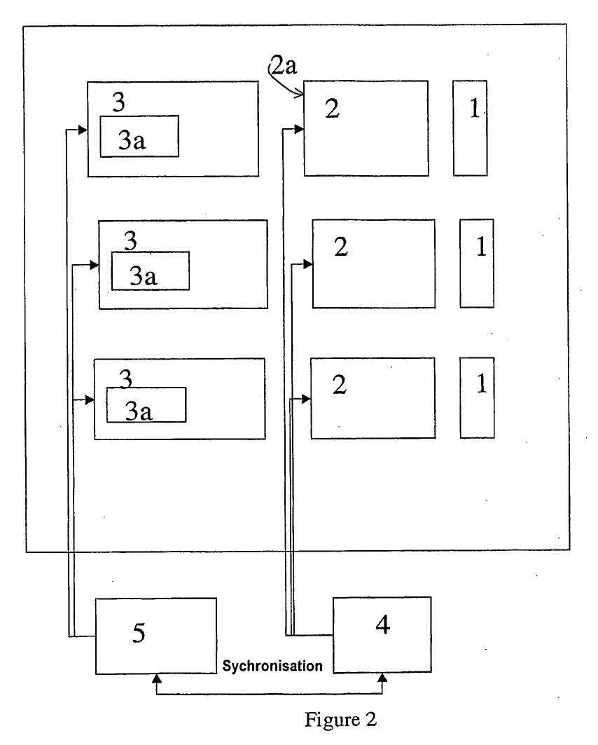

FIG. 2 depicts schematically a rapid camera according to the invention comprising a plurality of acquisition modules;

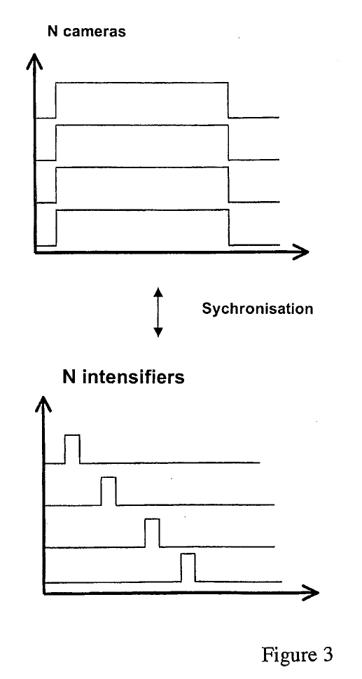

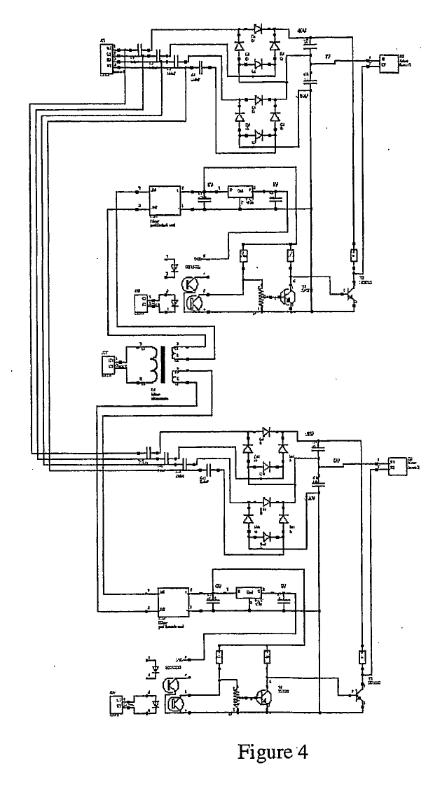

FIG. 3 depicts the pulse times of the intensifiers and of the standard cameras within the rapid camera according to the invention;

FIG. 4 is an example of a 400 V pulse-type supply card for the intensifiers;

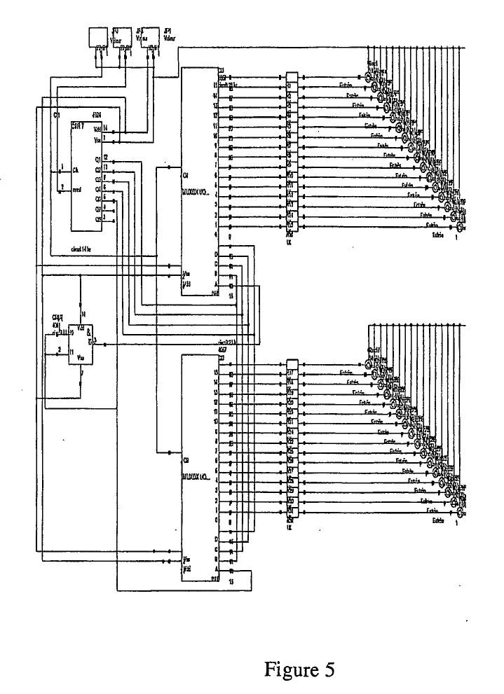

FIG. 5 is an example of a low-voltage synchronisation card used for the invention;

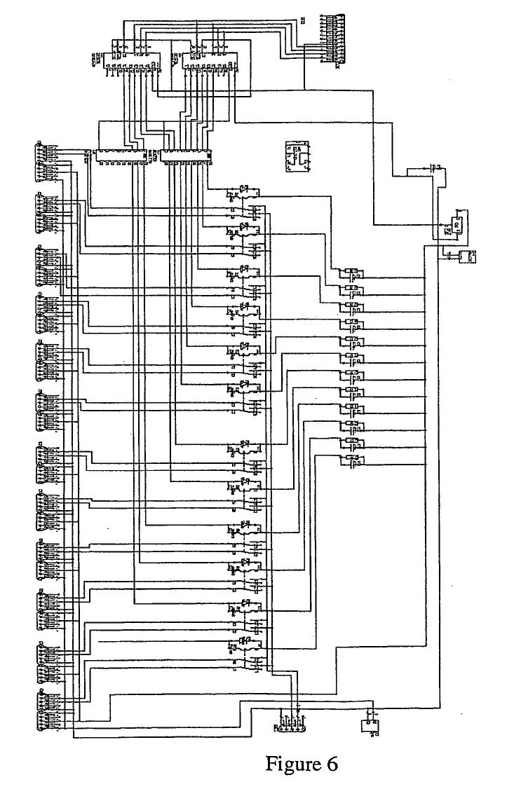

FIG. 6 is an example of a fine control card for the standard cameras according to the invention;

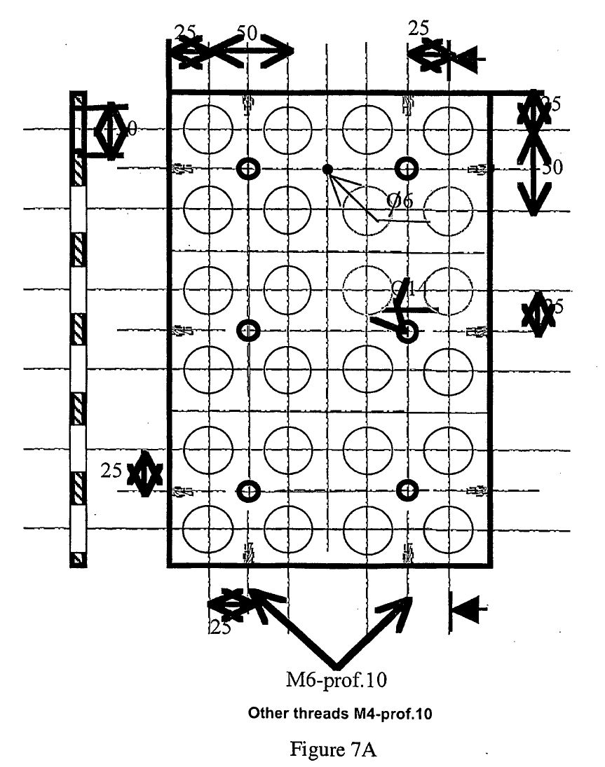

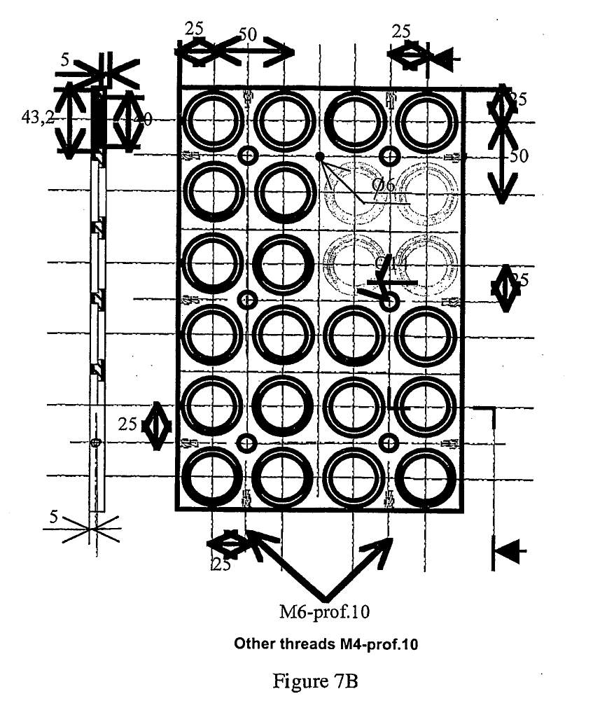

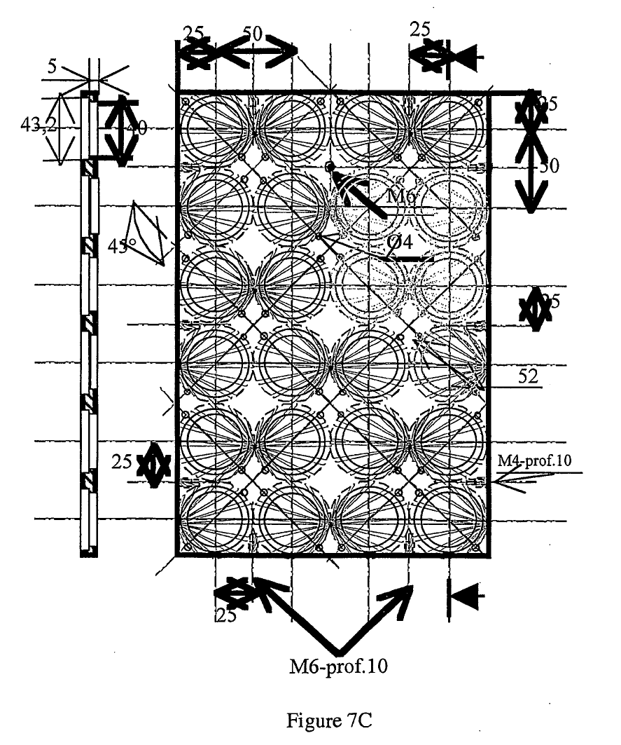

FIG. 7a depicts a support plate for fixing the standard cameras according to the invention;

FIG. 7b depicts a support plate for fixing the standard intensifiers according to the invention;

FIG. 7c depicts a support plate for fixing the objectives according to the invention.

The rapid camera according to the invention is composed of a plurality of acquisition modules 10 as illustrated in FIG. 1. Such a module comprises an objective 1, an image intensifier 2 and an intelligent standard camera 3 of the type comprising a memory 3a.

In operation, the objective forms the image on the front face 2b of the image intensifier 2, which fulfils the role of an obturator. In the absence of a supply voltage, the intensifier blocks the image on its front face. Under a high-voltage pulse, for example around 400 volts, the intensifier transmits the intensified image to its rear face 2a. The image therefore forms on the rear face 2a and is visible to the camera 3 during the supply period.

It is thus necessary to ensure acquisition by the camera during this period of time.

To do this, according to one embodiment, the standard camera 3 is in permanent capture mode, which means that the image is recorded and stored in the memory 3a as soon as it is available. The captured image therefore corresponds to the displayed image fixed in time by the obturator.

It will be understood that the zone for capture of the image by the camera of the acquisition module 10 is adapted according to this embodiment to the rear part of the intensifier and to its resolution.

In order to obtain a series of images, and as illustrated in FIG. 2, a plurality of acquisition modules 10 are disposed by offsetting the opening time of the various obturators whilst ensuring that the standard cameras 3 of the acquisition modules are in image capture mode during this time, as illustrated in FIG. 3.

As many acquisition modules are positioned as there are images that it is wished to obtain.

It should be noted that the use of an intensifier as an obturator is particularly advantageous in relation to the present invention for rapid obturation frequency.

The intensifier known by the trade name SuperGen®, developed by the company Photonis, has in fact an obturation period of less than 100 ns, and typically around 50 ns.

The function of the intensifier used according to the present invention is therefore a rapid obturation, the formation of the image to be acquired on its rear face and the intensification of the light rays.

The acquisition modules comprise for example a standard camera of the VCM type. This type of camera comprises, in a manner known per se, a means of digitising the image from the light signals received such as for example from the CCD or CMOS sensors.

The standard cameras used comprise at least one memory 3a for storing the image received. This memory stores the captured image in order to subsequently restore it at a display station, for example of the computer type.

This is because, according to the invention, each standard camera remains in the integration position for a long period while the associated obturator is not open. No light is therefore captured (absence of light), except during the opening time of the obturator. After integration, each standard camera independently manages the transfer of the image to a memory. In the absence of such a memory 3a, a person skilled in the art will understand that the image captured during the opening time of the obturator would be lost, and could not be displayed subsequently.

According to the invention, the content of the memory of the standard cameras corresponding to the opening time of the obturator is then recovered by means of a computer program.

All the images recovered from the various acquisition modules then allow the reconstruction of a succession of images at a high frequency.

The control and synchronisation modules 4 and 5 of the standard cameras and intensifiers are now described. By synchronising these two means, it is ensured that a standard camera of an acquisition module is able to digitise the image when the associated obturator is open.

As illustrated in FIG. 3, all the standard cameras are therefore in digitisation position when the obturators open and close.

The module 4 comprises for example a clock and a 400 V power supply and a means of synchronisation with the module 5. The latter makes it possible to supply and control the cameras from a standard computer, for example of the PC type.

In general terms, the clock signal used is defined so that its frequency corresponds to the image acquisition frequency and the duration of its high level corresponds to the intensifier obturation time.

For a camera comprising 24 acquisition modules 10, use is made for example of 12 pulse-type supply cards, one card controlling two intensifiers.

This pulse-type supply card as illustrated in FIG. 4 supplies for example independently two image intensifiers. This card is able to transform a pulse of a fixed duration and with a voltage varying from 0 to 5 V into a pulse of the same duration but with a voltage varying from +20 V (low level) to −400 V (high level). In addition, the electrical characteristics of the intensifiers mean that these supplies must be floating.

An example of a low-voltage synchronisation card is for example illustrated in FIG. 5. This is a demultiplexing card with one input to 32 outputs. The input is connected to the clock and the outputs are connected in pairs to a pulse-type supply card as illustrated in FIG. 4. At each rising edge of the clock, the demultiplexer activates a different output and sends to it a pulse, the duration of whose high level is defined by the form of the clock.

The control can also be achieved by a processor of the DSP type integrated in the intelligent standard camera and controlling the digitisation. This DSP is synchronised with the obturator control means in order to ensure that the digitisation is provided when the obturator is open.

Finally, the system according to the invention contains a computer application installed on a computer, for example of the PC type. This application performs the functions of acquisition and transfer of the images coming from the various cameras.

Each camera has an RS232 connection that must be connected to a computer in order to be able to dialogue and exchange programs and data. A splitter as illustrated in FIG. 6 allows dialogue of a single computer with 12 cameras. For this purpose, a control word is sent over the parallel port of the computer corresponding to the number of the camera with which it is wished to communicate, and the card in FIG. 6 orients the RS232 flow to the corresponding camera. Here again it is just a case of a 1 to 12 multiplexing card.

In order to provide the positionings of the 24 cameras according to the invention, use is made for example of a succession of plates carrying the successive elements of the camera according to the invention: a camera support plate, a intensifier support plate and an objective support plate. These plates are illustrated in FIGS. 7a, 7b and 7c.

In particular the lens support plate is such that each objective can be translated independently. This enables each camera to display the same image while, through their different positions, their viewpoints are different. This method is for example known by the term “lens shift” (the English term for “lens shift”).

The above detailed description therefore illustrates an example embodiment of a rapid camera comprising at least one objective (1) and a plurality of acquisition modules, each of the said modules comprising a means (2a) of forming an image through at least one obturation means (2), an image digitisation means (3) and a means for storing a digitised image (3a), the said camera also comprising a means (4) of controlling each of the said obturation means able to open them for a predetermined exposure time, and means (5) of fine control of the digitisation means (3) synchronised with the said control means so as to activate the digitisation when the obturation means associated with the digitisation means within an acquisition module is open.

Illustrated in FIG. 2 and on the lens support in FIG. 7c, a plurality of objectives has been shown, for example one per acquisition module. It is however understood the objective of the rapid camera may be a single one if the field of the objective corresponds to all the acquisition modules according to the invention. In particular, the field of the objective used is adapted to the number of acquisition modules of the rapid camera according to the invention.

In addition, a description has been given in the above embodiment of the use of an intensifier in the acquisition modules for performing the obturation and image formation functions. It should be understood that it is also possible to use any rapid obturation means of a known type, such as electro-optical cells, LCD panels or acousto-optical modulators, as well as any means of forming the image following obturation so that the standard camera can display the image like a frosted sheet, a translucent screen.

The rapid camera according to the invention, through its frequency of image acquisition, is particularly adapted to the imaging of rapid phenomena such as crack propagations.

1. A rapid camera comprising at least one objective (1) able to form an image, and a plurality of acquisition modules, each of the said modules comprising an obturation means (2) and an image formation means (2a), an image digitisation means (3) and a means for storing a digitised image (3a), the said rapid camera also comprising means (4) of controlling each of the said obturation means able to open them for a predetermined exposure time, characterised in that
the said image formation means is arranged to receive the said image from the said obturation means, and in that
the said rapid camera comprises a fine control means (5) arranged to fine control the said digitisation means (3), the said fine control means being synchronised with the said control means so as to activate the digitisation when the said obturation means associated with the said digitisation means within an acquisition module is open.

2. A rapid camera according to claim 1, characterised in that the said obturation means is an intensifier.

3. A rapid camera according to claim 2, characterised in that the said means of forming an image is the rear face of the said intensifier.

4. A rapid camera according to claim 1, characterised in that the said digitisation means is a camera sensor.
